(19) United States
(12) Patent Application Publication
(10) Pub. No.: US 2002/0097145 A1
(43) Pub. Date: Jul. 25, 2002

(54) INTEGRATED VEHICLE SECURITY SYSTEM UTILIZING FACIAL IMAGE VERIFICATION

(76) Inventors: DAVID M. TUMEY, SAN ANTONIO, TX (US); WAYNE J. COLTON, SAN ANTONIO, TX (US)

Correspondence Address: WAYNE J COLTON INC, THE MILAM BUILDING SUITE 1032, 115 EAST TRAVIS STREET, SAN ANTONIO, TX, 78205, US

(21) Appl. No.: 08/964,699

(22) Filed: Nov. 6, 1997

(51) Int. Cl. B60R 25/10

(52) U.S. Cl. 340/426; 340/5.53

(57) ABSTRACT

A method and apparatus for preventing theft of, and/or facilitating authorized access to, automotive vehicles generally comprises an image acquisition device adapted to generate signals representative of a human facial image wherein a processor associated with the image acquisition device is adapted to operatively receive the signals and generate an output relative to recognition or non-recognition of the human facial image. A response interface is associated with the processor and adapted to effect a vehicle security measure responsive to the recognition or non-recognition of the human facial image. An enrollment interface is adapted for enrolling authorized human users.

The processor is adapted to compare signals generated by the image acquisition device with stored images of authorized users, generally by a face recognition engine which may be implemented with either a neural network or principal component analysis or their equivalent. Processing by the face recognition engine is facilitated by providing a morphological pre-processor which may screen images for quality or, in at least one embodiment, perform some verification functions. A postprocessor may be provided to make the determination of recognition or non-recognition based upon a predetermined threshold value of recognition.

A triggering event interface is provided for communicating to the system the existence of those conditions necessitating verification of the user. Such events may include the opening of a car door, attempts to start the vehicle or attempts to access the vehicle. A response interface is also provided for effecting appropriate vehicle security measures. The response interface is generally one or more interconnections to the vehicle's microprocessor, door lock relay or alarm system. This interface will function to disable operation of the vehicle and/or sound the alarm in the case of attempted unauthorized use or access and will also serve to facilitate access to the vehicle in the case of authorized use.

### FIELD OF THE INVENTION

The present invention relates to vehicle security. More particularly, the invention relates to a method and apparatus for providing increased vehicle security wherein facial image verification is used to determine whether an individual is authorized to have access to and/or operate the vehicle where after the individual is either granted or denied use.

### BACKGROUND OF THE INVENTION

Vehicle security is an ever-increasing concern. As violent crime rates have recently dropped, theft, and in particular automobile theft, has skyrocketed. And although violent crime in general appears to have subsided, car-jacking persists as not only an extremely terrifying situation, but a particularly dangerous one. Faced with the loss of a major personal possession—often absolutely necessary in the daily ritual of traveling to work, school or the local grocery, the vehicle's occupants may often hesitate to abandon their car to a thief. The result is all too often an explosion of violence, with the thief erupting into gunfire or stabbing the rightful owner.

Unfortunately, presently available theft prevention devices are either ineffective or simply so inconvenient to use that the vehicle owner foregoes their protection. For instance, conventional car alarms are typically seen as an annoyance to all but the rightful owner. The common reaction to a car alarm in a public parking lot is no reaction at all—most people simply ignore it, allowing a thief plenty of opportunity to disable the alarm and abscond with the vehicle. In residential apartment complexes, the conventional car alarm is more often a source of late-night discontent between neighbors than a deterrent against crime. While some manufacturers have responded by making available devices that operate to physically secure the vehicle against theft, such as steering wheel locks, these devices are inconvenient to use. The busy car owner is required to place and remove the device at every stop throughout the day in order to realize its full benefit. As a result, the hurried user often foregoes this type of protection altogether. Furthermore, such devices typically only deter the thief to a more opportune target—unless the vehicle with the device is the one the thief really wants, in which case the device is quickly removed with a hack saw.

Most alarming is that of all of the theft prevention methods and apparatus thus far proposed, none address the safety of the vehicle's occupants during a car-jacking. Neither a disabled car alarm nor a stowed steering wheel lock will either facilitate the occupant's safety or prevent theft of the vehicle. Manufacturers, without any practical alternative at their disposal, have thus far been forced to turn a blind eye to this most egregious situation.

With these and other shortcomings of the prior art in mind, it is a primary object of the present invention to improve over the prior art by providing a method and apparatus for the prevention of vehicle theft which is both noninvasive to the user and effective at all times.

It is a further object of the present invention to provide such a method and apparatus which is cost effective and may be readily implemented in both new and used automobiles. As yet another object, the present invention strives to provide a method and apparatus which may be implemented in combination with other security measures as may already exist within the vehicle so as to complement and add to overall security, rather than present a compromise.

With these and other objects in mind, as will be apparent upon review of all that is disclosed herein, the following invention is presented as summarized herein below.

### SUMMARY OF THE INVENTION

In accordance with the foregoing objects, the present invention—a method and apparatus for preventing theft of, and/or facilitating authorized access to, automotive vehicles—generally comprises an image acquisition device adapted to generate signals representative of a human facial image wherein a processor associated with the image acquisition device is adapted to operatively receive the signals and generate an output relative to recognition or non-recognition of the human facial image. A response interface is associated with the processor and adapted to effect a vehicle security measure responsive to the recognition or non-recognition of the human facial image. The system may also comprise an enrollment interface adapted for enrolling authorized human users.

The enrollment interface generally provides a lock for controlling the introduction of authorized users and/or their deletion from the system. The lock may be a tumbler lock, cipher lock, stand-alone computer, or any other equivalent. In at least one embodiment, the enrollment lock is provided with a key for enabling the functions provided thereby.

The processor is adapted to compare signals generated by the image acquisition device with stored images of authorized users. This comparison is generally performed by a face recognition engine which may be implemented with either a neural network or principal component analysis or their equivalent. Processing by the face recognition engine is facilitated by providing a morphological pre-processor which may screen images for quality or, in at least one embodiment, perform some verification functions. A postprocessor may be provided to make the determination of recognition or non-recognition based upon a predetermined threshold value of recognition.

A triggering event interface is provided for communicating to the system the existence of those conditions necessitating verification of the user. Such events may include the opening of a car door, attempts to start the vehicle or attempts to access the vehicle. A response interface is also provided for effecting appropriate vehicle security measures. The response interface is generally one or more interconnections to the vehicle's microprocessor, door lock relay or alarm system. This interface will function to disable operation of the vehicle and/or sound the alarm in the case of attempted unauthorized use or access and will also serve to facilitate access to the vehicle in the case of authorized use.

The invention also includes the method for use of the above described apparatus, generally comprising enrolling at least one authorized user, verifying the authorization status of a user upon a triggering event and effecting an appropriate responsive action.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in functional block diagram, the theft prevention aspects of the preferred embodiment of the present invention;

FIG. 2 shows, in functional block diagram, the authorized access aspects of the preferred embodiment of the present invention;

FIG. 3 shows, in functional block diagram, a neural network implementation of the face recognition function of the preferred embodiment of the present invention;

FIG. 4 shows, in flowchart, average face and eigenface generation for a principal component analysis implementation of the face recognition function of the preferred embodiment of the present invention;

FIG. 5 shows, in flowchart, a principal component analysis implementation of the face recognition function of the preferred embodiment of the present invention; and

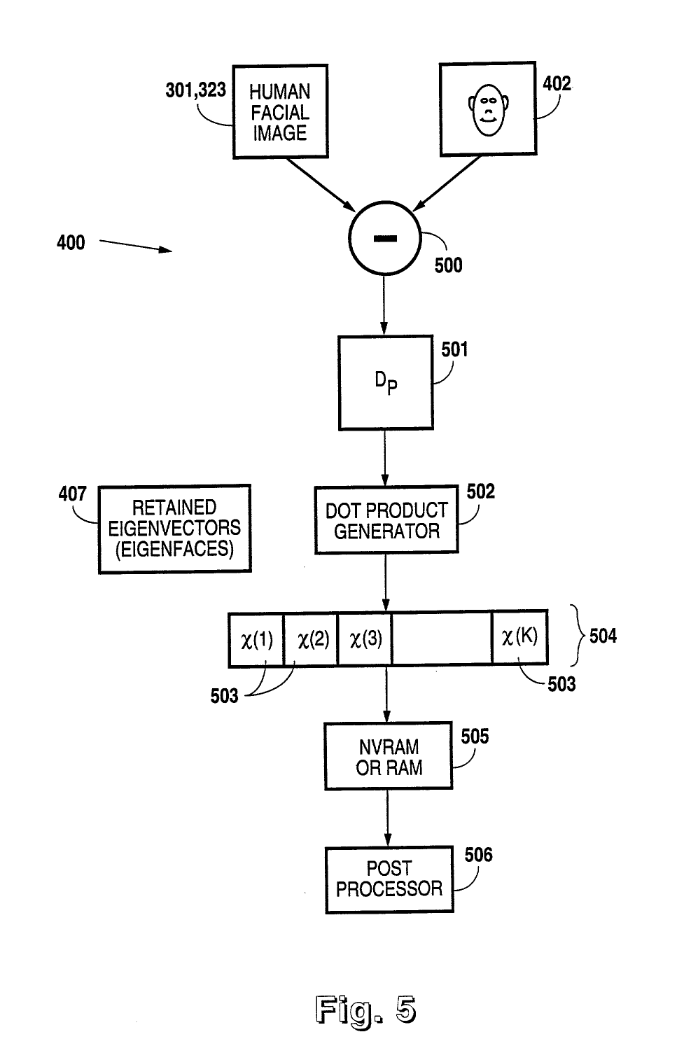

FIG. 6 shows, in flowchart, details of the operation of the preferred embodiment of the present invention.

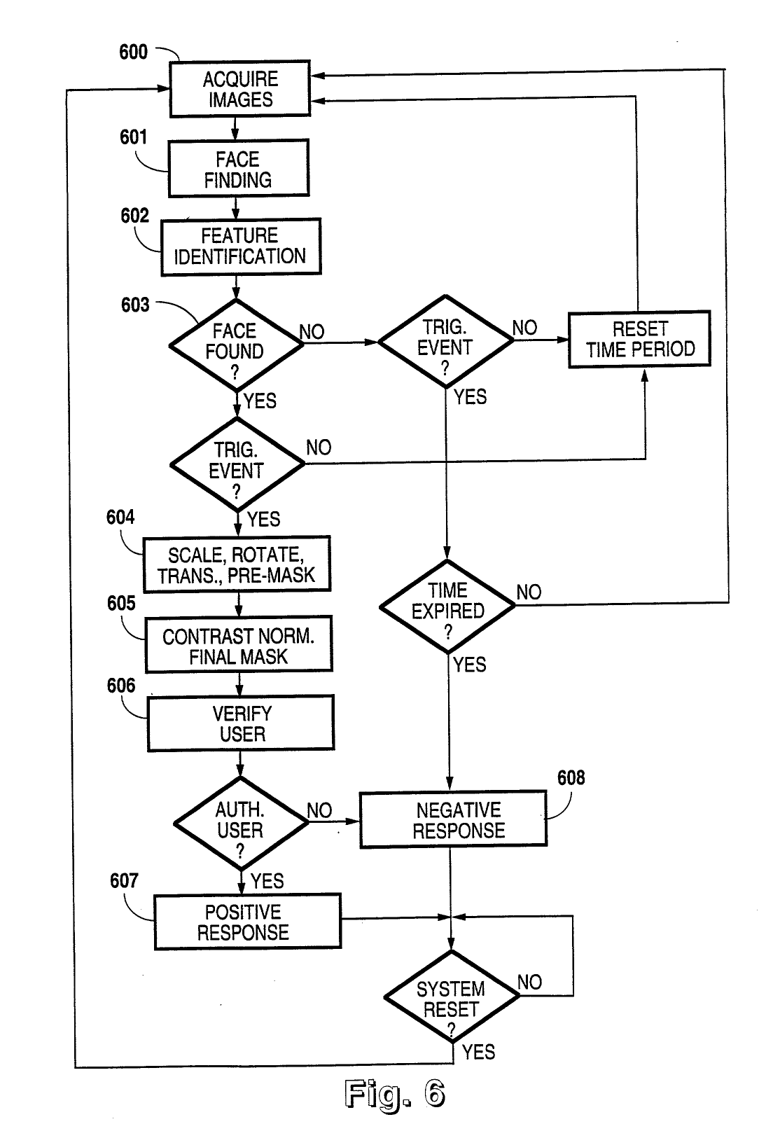

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention 100—a method and apparatus for preventing theft of, and/or facilitating authorized access to, automotive vehicles, the scope of which is limited only by the claims appended hereto.

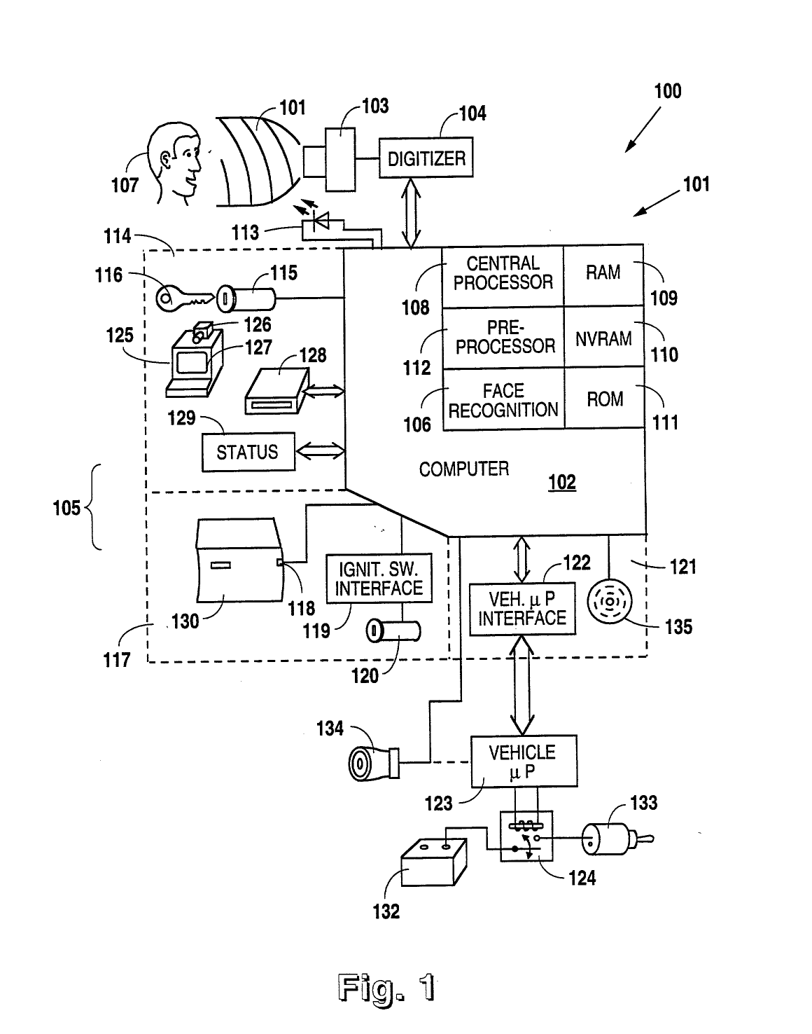

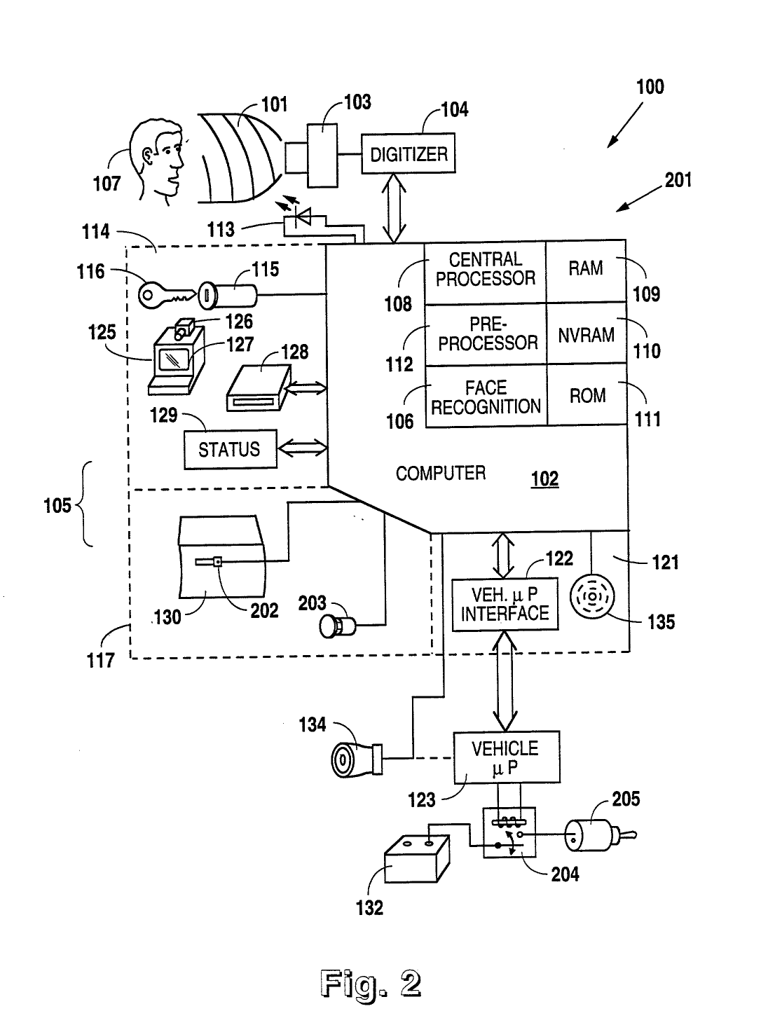

As particularly shown in FIGS. 1 and 2, an apparatus 100 for preventing vehicle theft, and/or for facilitating authorized access to a vehicle, generally comprises a computer 102, video camera 103 and digitizer 104, and system interface hardware 105. As will be understood further herein, upon triggering of a verification event, human facial images 301 captured by the camera 103 are digitized for processing by a facial recognition engine 106 within the computer 102. An output signal, indicative of recognition or non-recognition of a human user 107, is thereby generated for the conduct of an appropriate responsive action. In the case of vehicle theft prevention 101, the appropriate responsive action may be the enabling or disabling of the vehicle's engine. When the present invention 100 is utilized to facilitate authorized access 201 to a vehicle, the appropriate responsive action may be the unlocking, or the prevention of the unlocking, of the vehicle's doors. Those of ordinary skill in the art will quickly recognize myriad alternative scenarios, however, in which the teachings of the present invention 100 may be implemented, especially after reading the following detailed description of the preferred embodiments. All such implementations should therefore be considered substantial equivalents of the enabling embodiments described and claimed herein.

Referring now specifically to FIG. 1, there is shown an implementation 101 of the present invention 100 as adapted for the prevention of vehicle theft. The computer 102 is shown to generally comprise a central processor (CP) 108, well known in the art and commercially available under such trademarks as “INTEL 486”, “PENTIUM” and “MOTOROLA 68000”; conventional random access memory (RAM) 109; conventional nonvolatile RAM 110; and conventional read only memory (ROM) 111. A face recognition engine 106, which may comprise hardware, software, or any combination thereof, is implemented as part of the computer 102. Although any equivalent face recognition engine may be utilized, the preferred embodiment of the present invention 100 comprises either a neural network 300 or principal component analysis (PCA) 400 implementation. Each of these implementations 300, 400 is described in detail further herein. Finally, the computer 102 further comprises an appropriate preprocessing function 112 to prepare acquired human facial image data 301 for efficient and accurate processing by the face recognition engine 106.

A video camera 103 is operably associated with the computer 102 through a video digitizer 104. Although the video camera 103 may take virtually any form, the preferred embodiment of the present invention 100 comprises a video camera 103 adapted for ready digitization of the captured image 301, such as the well known charge coupled device (CCD) camera. As will be better understood upon reviewing those portions of this disclosure detailing the operation of the theft prevention aspects 101, it is preferable, for the theft prevention aspects 101 of the present invention 100, that the video camera 103 be mounted, facing the driver 107, in the vehicle's dashboard. The video digitizer 104 can be any one of the many available off-the-shelf units as commonly employed in personal computers for the acquisition of live video images or any custom equivalent of the same. Exemplary of the many available digitizer units 104 are those commercially available under such trademarks as “SNAPPY” and “MATROX METEOR”. The video camera 103 may also be adapted to be sensitive to infrared (IR), or other non-visible wavelengths, in order that any adverse affects derivative operation of the present invention 100 in varying lighting environments may be minimized. In the case of using such an adapted camera 103, the preferred embodiment of the present invention 100 further comprises a source 113, such as an IR light emitting diode (LED), for illuminating the user 107 with the desired wavelength light.

System interface hardware 105 is provided for enrolling one or more human users 107, communicating verification events to the computer 102 and effecting appropriate responsive actions within the vehicle. In the preferred embodiment of the present invention 100, there is provided an enrollment interface 114 generally comprising an enrollment lock switch 115 and key 116; a triggering event interface 117 generally comprising door sensing switches 118 and/or an interconnection 119 to the vehicle's ignition switch 120; and a response interface 121 generally comprising a vehicle microprocessor interface 122 to the vehicle's internal microprocessor 123 and/or starter relay 124.

The enrollment interface 114 provides a manner for introducing human facial image data 301, associated with authorized users 107, to the theft prevention aspects 101 of the present invention 100. In implementing the enrollment interface 114, an enrollment lock 115 provides a secure barrier against unauthorized introduction of surreptitious users. Although the preferred embodiment of the present invention 100 makes use of a conventional key-type lock, such as that commonly utilized in automobile ignition systems, the enrollment lock 115 may comprise any hardware or software barrier performing the equivalent function. Associated with the enrollment lock 115 is an enrollment key 116. In the preferred embodiment of the present invention 100, the enrollment key 116 comprises an ordinary automobile key. It is to be understood, however, that any other device of equivalent structure and/or function may serve as the enrollment key 116. For example, a touch pad or cipher lock may be used in embodiments wherein the enrollment lock 115 comprises an electrical or mechanical combination-type lock. In yet another embodiment of the enrollment interface 114, the enrollment lock 115 may comprise a stand-alone computer 125 where the corresponding enrollment key 116 may be a password control. In such an embodiment, a video camera 126 and digitizer 127 each associated with the computer 125 capture the facial image 301 of a human user 107 whose authorization status is authenticated by knowledge of the password. The captured image 301 may then be encoded and stored in any variety of electronic media for secure introduction, through an appropriate interface 128, into the theft prevention aspects 101 of the present invention 100. In operation, the enrollment key 116 preferably provides at least three operating conditions. In the first, or “locked,” condition, the theft prevention aspects 101 are locked to prevent, or block, enrollment, as will be better understood further herein, of users 107. In the second, or “enrollment,” condition, the introduction to the theft prevention aspects 101 of facial image data 301 associated with new users 107 is enabled. In the third, or “delete user,” condition, the removal of previously enrolled users 107, as detailed further herein, from the enrollment database of the theft prevention aspects 101 is enabled. Finally, the enrollment interface 114 preferably comprises a manner 129 for conveyance of enrollment operation status, including an assigned user identification (ID) and indication of successful enrollments, to the user 107. Such information can be conveyed to and from the system 100 by any combination of well-known methods, including tone generation, synthesized voice and voice recognition, liquid crystal display (LCD), LED and keypad entry.

The triggering event interface 117 provides a manner for communicating to the computer 102 the existence of any condition, as will be better understood further herein, necessitating verification of the authorization status of a human user 107. In the preferred embodiment of the present invention 100, interconnections are made to the automobile manufacturer provided door-sensing switches 118 and ignition switch 120. The door sensing switches 118, now almost universally provided in new automobiles, detect the opening or closing of the driver's side door or doors, the passenger's side door or doors, or any combination thereof 130. As well known to those of ordinary skill in the art, these door sensing switches 118 each generally comprise a single-pole, single-throw (SPST), momentary, push-button switch and are easily integrated into older vehicles wherein they may not exist from the manufacturer. An ignition switch 120 for starting, or enabling the starting of, the vehicle's engine or motor is generally provided in newer and older automobiles alike. As with the door sensing switches 118, however, those of ordinary skill in the art will have readily available many alternatives in implementing this aspect of the present invention 100.

In further accordance with the preferred embodiment of the present invention 100, the interconnection to the door sensing switches 118 communicates the opening of any door 130 of the host vehicle to the computer 102 of the theft prevention aspects 101. The interconnection 119 to the vehicle's ignition switch 120 communicates to the computer 102 of the theft prevention aspects 101 any attempt to start, or enable starting of, the vehicle. Additionally, the theft prevention aspects 101 may be configured to continuously monitor the presence of a human facial image 301 within the field of view 131 of the camera 103. In such a configuration, movement of the human facial image 301 from within the camera's field of view 131 may also constitute a triggering event condition. As will be better understood further herein, the communication of any of these triggering event conditions may initiate a verification event, in which case the authorization status of the vehicle's user 107 will be determined and an appropriate response effected.

Because most foreign and domestic automobiles produced after 1986 were or are manufactured with an internal microprocessor 123 responsible for controlling many of the vehicle's basic functions, including the starting and operation of the vehicle's engine or motor, the response interface 121 of the preferred embodiment of the present invention 100 generally comprises a vehicle microprocessor interface 122 for effecting appropriate responsive actions through the vehicle's internal microprocessor 123. It is to be understood, however, that the linking of the computer 102 of the theft prevention aspects 101 of the present invention 100 to the vehicle, for the conduct of responsive actions, may also be accomplished by direct connection to the controlled function, as will be better understood further herein. In the typical automotive configuration, the vehicle's internal microprocessor 123 is operably connected to a starter relay 124 electrically interposed between the vehicle's battery 132 and starter motor 133. In other automotive configurations, it is envisioned that the present invention may be implemented in electric-type vehicles, wherein the vehicle's internal microprocessor 123 may directly control flow of electric current to the vehicle's electric motor. Regardless of vehicle type, or presence of an internal microprocessor 123, however, those of ordinary skill in the art will be readily able to implement a response interface 121 from the computer 102 of the theft prevention aspects 101 to the appropriate vehicle system, or systems, affecting operation of the vehicle's engine or motor. Notwithstanding its particular implementation, the response interface 121 will generally function to disable vehicle operation in the event of attempted unauthorized vehicle use and/or enable vehicle operation only in response to verified authorized vehicle use. As an additional feature, the response interface 121 may also comprise an interconnection, either directly or through the vehicle's internal microprocessor 123, from the computer 102 of the theft prevention aspects to any installed vehicle alarm system 134. Such an alarm system 134 may include, but is in no way limited to: conventional sirens, Global Positioning System (G.P.S.) tracking systems, automated cellular interfaces to alarm monitoring companies or police departments, or transponder systems. Finally, the response interface 121 preferably also comprises an interconnection to a buzzer 135, or other like signaling device, for providing the user 107 a warning of imminent negative responsive actions, as will be understood further herein.

Referring now specifically to FIG. 2, there is shown an implementation 201 of the present invention 100 as adapted for facilitating authorized access to a vehicle. The computer 102, which may be a shared resource with respect to the computer 102 of the vehicle theft prevention aspects 101, is shown to generally comprise a central processor (CP) 108, well known in the art and commercially available under such trademarks as “INTEL 486”, “PENTIUM” and “MOTOROLA 68000”; conventional random access memory (RAM) 109; conventional nonvolatile RAM 110; and conventional read only memory (ROM) 111. As in the vehicle theft prevention implementation 101, a face recognition engine 106, which may comprise hardware, software, or any combination thereof, is implemented as part of the computer 102. Although any equivalent face recognition engine may be utilized, the preferred embodiment of the present invention 100 comprises either a neural network 300 or principal component analysis (PCA) 400 implementation. Each of these implementations 300, 400 is described in detail further herein. Finally, the computer 102 further comprises an appropriate preprocessing function 112 to prepare acquired human facial image data 301 for efficient and accurate processing by the face recognition engine 106.

A video camera 103 is operably associated with the computer 102 through a video digitizer 104. Although the video camera 103 may take virtually any form, the preferred embodiment of the present invention 100 comprises a video camera 103 adapted for ready digitization of the captured image 301, such as the well known charge coupled device (CCD) camera. As will be better understood upon reviewing those portions of this disclosure detailing the operation of the authorized access aspects 201, it is preferable, for the authorized access aspects 201 of the present invention 100, that the video camera 103 be mounted, facing the driver's side exterior of the vehicle, in the vehicle's roof panel, exterior door panel adjacent the vehicle's door handle, or driver's side door frame. It is contemplated that the video camera 103 of the authorized access implementation 201 may be a shared resource with the theft prevention implementation 101. Accordingly, it is noted that with available fiber optic and other technologies, as are well known to those of ordinary skill in the art, the shared camera 103 may be adapted to simultaneously receive a split image representative of both the image viewed within the vehicle and the image viewed without the vehicle. The video digitizer 104, which may also be a shared resource with respect to the vehicle theft prevention embodiment 101, can be any one of the many available off-the-shelf units as commonly employed in personal computers for the acquisition of live video images or any custom equivalent of the same. Exemplary of the many available digitizer units 104 are those commercially available under such trademarks as “SNAPPY” and “MATROX METEOR”. The video camera 103 may also be adapted to be sensitive to IR, or other non-visible wavelengths, in order that any adverse affects derivative operation of the present invention 100 in varying lighting environments may be minimized. In the case of using such an adapted camera 103, the preferred embodiment of the present invention 100 further comprises a source 113, such as an IR LED, for illuminating the user 107 with the desired wavelength light.

As in the theft prevention implementation 101, system interface hardware 105 is provided for enrolling one or more human users 107, communicating verification events to the computer 102 and effecting appropriate responsive actions within the vehicle. In the preferred embodiment of the present invention 100, there is provided an enrollment interface 114 generally comprising an enrollment lock switch 115 and key 116; a triggering event interface 117 generally comprising an interconnection to door handle sensing switches 202 and/or an interconnection to a specifically adapted access, or lock, switch 203; and a response interface 121 generally comprising an interconnection to the vehicle's door lock relay 204.

The enrollment interface 114, which may also be a shared resource with the theft prevention aspects 101, provides a manner for introducing human facial image data 301, associated with authorized users 107, to the authorized access aspects 201 of the present invention 100. In implementing the enrollment interface 114, an enrollment lock 115 provides a secure barrier against unauthorized introduction of surreptitious users. Although the preferred embodiment of the present invention 100 makes use of a conventional key-type lock, such as that commonly utilized in automobile ignition systems, the enrollment lock 115 may comprise any hardware or software barrier performing the equivalent function. Associated with the enrollment lock 115 is an enrollment key 116. In the preferred embodiment of the present invention 100, the enrollment key 116 comprises an ordinary automobile key. It is to be understood, however, that any other device of equivalent structure and/or function may serve as the enrollment key 116. For example, a touch pad or cipher lock may be used in embodiments wherein the enrollment lock 115 comprises an electrical or mechanical combination-type lock. In yet another embodiment of the enrollment interface 114, the enrollment lock 115 may comprise a stand-alone computer 125 where the corresponding enrollment key 116 may be a password control. In such an embodiment, a video camera 126 and digitizer 127 each associated with the computer capture the facial image 301 of a human user 107 whose authorization status is authenticated by knowledge of the password. The captured image 301 may then be encoded and stored in any variety of electronic media for secure introduction into the authorized access aspects 201 of the present invention 100. In operation, the enrollment key 116 preferably provides at least three operating conditions. In the first, or “locked,” condition, the authorized access aspects 201 are locked to prevent, or block, enrollment, as will be better understood further herein, of users 107. In the second, or “enrollment,” condition, the introduction to the authorized access aspects 201 of facial image data 301 associated with new users 107 is enabled. In the third, or “delete user,” condition, the removal of previously enrolled users 107, as detailed further herein, from the enrollment database of the authorized access aspects 201 is enabled. Finally, the enrollment interface 114 preferably comprises a manner 129 for conveyance of enrollment operation status, including an assigned user identification (ID) and indication of successful enrollments, to the user 107. Such information can be conveyed to and from the system 100 by any combination of well-known methods, including tone generation, synthesized voice and voice recognition, liquid crystal display (LCD), LED and keypad entry.

The triggering event interface 117 provides a manner for communicating to the computer 102 the existence of any condition, as will be better understood further herein, necessitating verification of the authorization status of a human user 107. In the preferred embodiment of the present invention 100, an interconnection is made to the automobile manufacturer provided door handle sensing switch 202. The door handle sensing switch 202, now almost universally provided in new automobiles for activating the interior lights of the host vehicle and/or incorporated into the vehicle's alarm system 134, detects attempts to open the driver's side door. As will be apparent to those of ordinary skill in the art, however, vehicles lacking a manufacturer installed door handle sensing switch 202 may be readily provided with an after market switch for implementation of the present invention 100. In the alternative, a specifically adapted switch 203, independent of the door handle, may also be provided for implementation of the present invention 100.

In further accordance with the preferred embodiment of the present invention 100, the interconnection to the door handle sensing switch 202, and/or the specifically adapted switch 203, communicates an attempt to open the driver's side door of the host vehicle, and hence the user's desire to gain access to the vehicle, to the computer 102 of the authorized access aspects 201 of the present invention 100. As will be better understood further herein, the communication of this triggering event condition may initiate a verification event, in which case the authorization status of the vehicle's user 107 will be determined and an appropriate response effected.

Because most new automobiles produced are manufactured with a door lock relay 204 responsible for operating the vehicles' electromechanical door locks 205, the response interface 121 of the preferred embodiment of the present invention 100 generally comprises an interface for effecting appropriate responsive actions through the vehicle's door lock relay 204, which in the typical automotive configuration, is electrically interposed between the vehicle's battery 132 and electromechanical door locks 205. It is to be understood, however, that the linking of the computer 102 of the authorized access aspects 201 to the vehicle, for the conduct of responsive actions, may also be accomplished by interface through a vehicle microprocessor interface 122 to the vehicle's internal microprocessor 123, in those vehicles wherein the internal microprocessor 123 controls the activation of the vehicle's electromechanical door locks 205, or by direct interface to the vehicle's electromechanical door locks 205, in those vehicle's not utilizing a door lock relay 204. In embodiments wherein the responsive action is effected through an interconnection 122 to the vehicle's internal microprocessor 123, the response interface of the authorized access aspects 201 may be a shared resource with the theft prevention aspects 101. Regardless of vehicle type, or presence of an internal microprocessor 123 and/or door lock relay 204, however, those of ordinary skill in the art will be readily able to implement a response interface 121 from the computer 102 of the authorized access aspects 201 to the appropriate vehicle system, or systems, affecting operation of the vehicle's door locks 205. Notwithstanding its particular implementation, the response interface 121 will generally function to prevent unlocking of the vehicle in the event of attempted unauthorized vehicle access and/or unlock the vehicle in response to attempted access by a verified authorized vehicle user 107. As an additional feature, the response interface 121 may also comprise an interconnection, either directly or through the vehicle's internal microprocessor 123, from the computer 102 of the authorized access aspects 201 to any installed vehicle alarm system 134. Such an alarm system 134 may include, but is in no way limited to: conventional sirens, G.P.S. tracking systems, automated cellular interfaces to alarm monitoring companies or police departments, or transponder systems.

Although the foregoing descriptions of the theft prevention and authorized access system interfaces 105 are exemplary of the preferred embodiments of the present invention 100, those of ordinary skill in the art will recognize many alternatives to the implementation of the various component interfaces 114, 117, 121, especially after having had the benefit of this detailed disclosure. For example, in vehicle's wherein the internal microprocessor 123 is responsible for starting of the vehicle, the interconnection 122 to the vehicle's internal microprocessor 123 made for effecting responsive actions may double as an interface for communicating the triggering event condition associated with attempts to start the vehicle. As yet another example, in embodiments where the enrollment interface 114 comprises a stand-alone computer 125, an electronic key for transferring the enrolled image 301 to the system 100 may double as a door lock key or ignition key. In such an embodiment, the need to semi-permanently store, in the system's nonvolatile RAM 110, facial image data 301 associated with authorized users 107 may be obviated.

As pointed out herein above, both the vehicle theft prevention aspects 101 and the vehicle access control aspects 201 of the present invention 100 may make use of a neural network 300 or PCA 400 facial image recognition engine 106 to generate an output signal indicative of recognition or non-recognition of a human user 107. It is to be understood, however, that there is a variety of methods by which the identification and verification element of the present invention 100 may be implemented. Although the methods may differ in computational structure, it is widely accepted, and very well known to those of ordinary skill in the art, that most such methods are functional equivalents. Notwithstanding the many possible alternative embodiments, two practical techniques—a neural network 300 and a PCA 400—are disclosed herein below in compliance with Applicant's duty to provide an enabling description of the best mode known for carrying out the present invention 100.

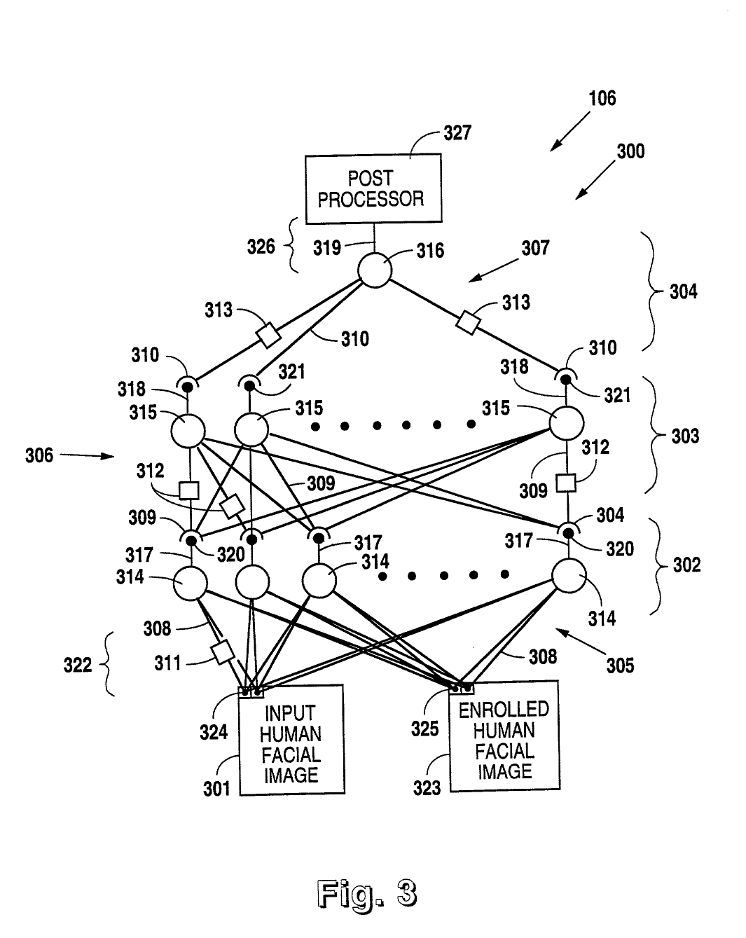

Referring now to FIG. 3, an exemplary neural network 300, appropriate for implementation of the present invention 100, is shown to comprise at least one layer of trained neuron-like units. Although those of ordinary skill in the art will recognize that fewer or more layers may be utilized depending on the related computational requirements of the overall system design, the preferred embodiment of the present invention 100 comprises three layers 302, 303, 304. According to the preferred embodiment, the neural network 300 includes an input layer 302, a hidden layer 303 and an output layer 304, each layer further comprising a plurality of trained neuron-like units 305, 306, 307. Each neuron-like unit is generally defined to comprise a plurality of dendrite-like units 308, 309, 310, each having associated therewith an adaptively determinable modulator 311, 312, 313; a soma-like unit 314, 315, 316; an axon-like unit 317, 318, 319; and a bouton-like unit 320, 321. For clarity in the drawings, many of the adaptively determinable modulators 311, 312, 313 have not been shown in FIG. 3. It is to be understood, however, that each dendrite-like unit 308, 309, 310 may have an adaptively determinable modulator 311, 312, 313 associated therewith. As will be better understood further herein, the resulting computational structure comprises a vast, multi-dimensional array of simple machine processors—the neuron-like units 305, 306, 307, each having multiple inputs comprising the dendrite-like units 308, 309, 310 and associated modulators 311, 312, 313 and a single output comprising the axon-like units 317, 318, 319 and bouton-like units 320, 321, wherein the soma-like unit 314, 315, 316 of each neuron-like unit 305, 306, 307 is the computational center. Although each processor 305, 306, 307 is individually limited to a simple or basic process, the synergistic effect of the processor array yields an extraordinarily powerful computational engine 300.

According to the preferred embodiment of the present invention 100, the dendrite-like units 308 of each neuron-like unit 305 in the input layer 302 comprise a receive channel 322 for receiving human facial image data 301, 323. Because the preferred embodiment of the present invention 100 utilizes a fully connected neural network 300, as is well known to those of ordinary skill in the art, every dendrite-like unit 308 of the input layer 302 receives data representative of every pixel 324, 325 of two human facial image data sets. The first set comprises the input human facial image data 301 as captured by the camera 103 of the present invention 100. The second set comprises one image 323 of a plurality of enrolled human facial images. Each of these data sets will be fully understood by those of ordinary skill in the art upon examination of the portions of this disclosure detailing training of the neural network 300 and subsequent operation of the system 100. The adaptively determinable modulator 311 of each dendrite-like unit 308 in the input layer 302 modulates each pixel 324, 325 of each set of human facial image data prior to summation and nonlinear transformation of that data, as detailed below, within each soma-like unit 314 of the input layer 302.

Each pixel 324, 325 of human facial image data 301, 323 may be represented as an input variable Xₐ. Likewise, each modulator 311 of each dendrite-like unit 308 in the input layer 302 may be considered a weighting factor Wₐ. Once presented to the soma-like units 314 of the input layer 302, the modulated, or weighted, inputs, which may be considered the product XₐWₐ, are summed. A threshold barrier β, necessary for maintaining values within a maximally meaningful range, is then subtracted from the sum of the products to arrive at a value α for input into a nonlinear transfer function (NTF) defined as:

$$\frac{1}{1 + {e}^{- α}} ,$$

where

α=(ΣₐXₐWₐ)−β.

The computational result of the processing within each soma-like unit 314 of the input layer 302 is a floating point number between zero and one, which is transmitted from each input layer neuron-like unit's soma-like unit 314 to the bouton-like unit 320 through the interposed axon-like-unit 317. The resulting value of each computation is then stored in each neuron-like unit's bouton-like unit 320 for input into the hidden layer 303.

Again because the preferred embodiment of the present invention 100 utilizes a fully connected neural network 300, every dendrite-like unit 309 of the hidden layer 303 receives the output value stored in every bouton-like unit 320 of the input layer 303. As in the input layer 302, the adaptively determinable modulator 312 of each dendrite-like unit 309 of the hidden layer 303 modulates each input layer output value prior to summation and nonlinear transformation, according to the same formulation utilized in the input layer 302, within each soma-like unit 315 of the hidden layer 303. The computational result of the processing within each soma-like unit 315 of the hidden layer 303 is again a floating point number between zero and one, which is transmitted from each hidden layer neuron-like unit's soma-like unit 315 to the bouton-like unit 321 through the interposed axon-like unit 318. The resulting value of each computation is then stored in each hidden layer neuron-like unit's bouton-like unit 321 for input into the output layer 304.

Finally, every dendrite-like unit 310 of the output layer 304 receives the output value stored in every bouton-like unit 321 of the hidden layer 303. As in the input and hidden layers 302, 303, the adaptively determinable modulator 313 of each dendrite-like unit 310 of the output layer 304 modulates each hidden layer output value prior to summation and nonlinear transformation, according to the same formulation utilized in the input and hidden layers 302, 303, within each soma-like unit 316 of the output layer 304. The computational result of the processing within each soma-like unit 316 of the output layer 304 is again a floating-point number between zero and one. In the output layer 304, the axon-like units 319 comprise an output channel 326 for transmission of a signal indicative of recognition or non-recognition of an input human facial image data set 301 and the bouton-like units may be dispensed with. According to one method for implementation of the present invention 100, the output layer 304 could comprise a single neuron-like unit 307 wherein output values near zero could indicate non-recognition and output values near one could indicate recognition, or vice versa. With other implementations, more computational power could be inserted into the output layer 304 through provision of multiple neuron-like units 307. In the latter case, any of a number of schemes, such as provision of a post-processor 327, decoder, or other devices as are known to those of ordinary skill in the art, may be employed to interpret the resultant multiple outputs in terms of recognition or non-recognition. In any case, all output layer configurations and associated hardware and software should be considered structural and functional equivalents to, and within the scope of, the present invention.

The neuron-like units 305, 306, 307 of each layer 302, 303, 304 of the present invention's neural network 300 may be implemented in software, hardware or any combination thereof, as is well known to those of ordinary skill in the art. For partial or full software implementations, the teachings of the present invention 100 may be characterized as utilizing a computer-based device to perform the steps of the disclosed methods, where the various input and output values may be considered variables upon which are performed various mathematical computations. For example, the axon-like units 317 of the input layer 302 may be considered variables representative of the values resultant the soma-like units' computations and the bouton-like units 320 may be considered functions which assign those variables to each dendrite-like unit 309 of the hidden layer 303. In hardware implementations, the dendrite-like units 308, 309, 310 may be a wire or an optical, electrical or other transducer having a chemically, optically, electrically or otherwise modifiable resistance associated therewith. Likewise, the axon-like units 317, 318, 319 and bouton-like units 320, 321 may be a wire or any optical, electrical or other transmitter. The soma-like units 314, 315, 316 may be implemented in any combination of programmable or discrete hardware.

Although the drawings depict the neural network 300 as a hardware array, it is to be understood that those of ordinary skill in the art will be able to implement the present invention 100 in myriad formats which, with increasing hardware utilization levels, will appear dramatically different than the functional block diagrams provided. It is also to be understood that, while the preferred embodiment of the present invention 100 utilizes a fully connected neural network 300, the present invention 100 may also be implemented with a concatenated neural network, as is well known to those of ordinary skill in the art, with only corresponding possible loss in computational and/or training power.

The adaptively determinable modulators 311, 312, 313, connecting each layer 302, 303, 304 of neuron-like units 302, 303, 304 to their respective inputs, determines the classification paradigm to be employed by the neural network 300. The weighting factors to be assigned to each of these modulators 311, 312, 313 are generated through a training process, wherein known human facial image characteristics are input to the neural network 300, the final and intermediate network outputs are observed, and the weighting factors are adjusted in response to the error between the known true final output and the observed final and intermediate outputs.

In the preferred embodiment of the present invention 100, the neural network 300 is trained through backward error propagation, as is well known to those of ordinary skill in the art. In accordance with this training method, all of the adaptively determinable modulator weights Wₐ and threshold barriers β of the still untrained neural network 300 are initially preset to small, nonzero, random numbers. Although the modulators 311, 312, 313 may be preset to the same value, Applicant has found that the learning rate, i.e. that rate at which the neural network 300 trains to give accurate results, is most often maximized through the selection of random values. Following initialization of the untrained neural network 300, human facial image data 301, 323 is input to the neural network 300 and the final output 326 or outputs are observed. The weight value assigned to each adaptively determinable modulator Wₖₒₗ, and the threshold barrier βₒₗ, of the output layer 304 is then adjusted according to the relationship

Wₖₒₗ*=Wₖₒₗ+GZₖₒₛEₖ,

where W*ₖₒₗ is the new weight value to be assigned to the modulators 313 of the k^{th} neuron-like unit 307 of the output layer 304; Wₖₒₗ is the previously assigned weight value of the modulators 313 of the k^{th} neuron-like unit 307 of the output layer 304; G is an empirically selected gain factor, detailed further herein, for influencing training rate and network accuracy; Zₖₒₛ is the actually observed output signal from the k^{th} neuron-like unit 307 of the output layer 304; and Eₖ is an error term corresponding to the k^{th} neuron-like unit 307 of the output layer 304 and generated according to the relationship

Eₖ=Zₖₒₛ(1−Zₖₒₛ)(Dₖₒₛ−Zₖₒₛ),

where Dₖₒₛ is the desired, or true, output signal of the k^{th} neuron-like unit 307 of the output layer 304. The error term Eₖ represents the degree to which the actually observed output or outputs from the output layer 304 differ from the output or outputs expected or desired for the particular training input human facial image data 301. The gain factor G is an empirically determined value, typically set to attenuate the training rate of the neural network 300, i.e. set to a value between zero and one. As is known to those of ordinary skill in the art, selection of a gain factor which is too high will generally cause the network 300 to train, i.e. reach a state of no further decreases to the error term Eₖ, rapidly, but will result in poor overall network accuracy. Conversely, selection of a gain factor which is lower will generally result in more accurate overall network performance, but selection of a gain factor G which is too low will prevent the network 300 from training within the practical capabilities of the implementing hardware and/or software. Because the optimal gain factor G is largely a function of the overall system 100 architecture and processor 108 capabilities, Applicant has found that a good rule of thumb is to initially set the gain factor G to a value near 0.5 and then make adjustments based upon observed training performance. Finally, it is noted that in training the neural network 300, the threshold barrier βₒₗ of the output layer 304 is treated as an extra output layer modulator weight.

After the training process calculates the necessary factors for the output layer 304, but prior to any further feed forward of input data, the weight value assigned to each adaptively determinable modulator Wⱼₕₗ, and the threshold barrier βₕₗ, of the hidden layer 303 is then adjusted according to the relationship

W*ⱼₕₗ=Wⱼₕᵢ+GYⱼₒₛEⱼ,

where W*ⱼₕₗ is the new weight value to be assigned to the modulators 312 of the j^{th} neuron-like unit 306 of the hidden layer 303; Wⱼₕₗ is the previously assigned weight value of the modulators 312 of the j^{th} neuron-like unit 306 of the hidden layer 303; G is the gain factor as detailed herein above; Yⱼₒₛ is the actually observed output signal from the j^{th} neuron-like unit 306 of the hidden layer 303; and Eⱼ is an error term corresponding to the j^{th} neuron-like unit 306 of the hidden layer 303 over all k neuron-like units of the output layer 304 and generated according to the relationship

Eⱼ=Yⱼₒₛ(1−Yⱼₒₛ)Σₖ(EₖWₖₒₗ),

where each Eₖ and Wₖₒₗ are taken from the calculations previously made with respect to the output layer 304. As in the output layer 304, the threshold barrier βₕₗ, of the hidden layer 303 is trained as an extra hidden layer modulator weight.

After the training process calculates the necessary factors for the output layer 304 and the hidden layer 303, but prior to any further feed forward of input data, the weight value assigned to each adaptively determinable modulator Wᵢᵢₗ, and the threshold barrier βᵢₗ, of the input layer 302 is then adjusted according to the relationship

W*ᵢᵢₗ=Wᵢᵢₗ+GXᵢₒₛEᵢ,

where W*ᵢᵢₗ is the new weight value to be assigned to the modulators 311 of the i^{th} neuron-like unit 305 of the input layer 302; Wᵢᵢₗ is the previously assigned weight value of the modulators 311 of the i^{th} neuron-like unit 305 of the input layer 302; G is the gain factor as detailed herein above; Xᵢₒₛ is the actually observed output signal from the i^{th} neuron-like unit 305 of the input layer 302; and Eⱼ is an error term corresponding to the i^{th} neuron-like unit 305 of the input layer 302 over all j neuron-like units of the hidden layer 303 and generated according to the relationship

Eᵢ=Xᵢₒₛ(1−Xᵢₒₛ)Σⱼ(EⱼWⱼₕₗ),

where each Eⱼ and Wₖₕₗ are taken from the calculations previously made with respect to the hidden layer 303. As in the output layer 304 and hidden layer 303, the threshold barrier βᵢ of the input layer 302 is trained as an extra input layer modulator weight.

After all of the new weight values for each adaptively determinable modulator 311, 312, 313 and each layer's threshold barriers are adjusted, the input facial image data 301 is again presented to the neural network 300. If the resulting error terms indicate acceptable values, the network 300 is deemed to be trained and no further training is necessary. In this case, the weight values and threshold barriers are frozen and the neural network 300 is ready for implementation of the present invention 100. If, conversely, the resulting error terms are not yet within acceptable values, the foregoing training process is repeated until acceptable levels are obtained. It is noted, as alluded to previously, that the gain factor G may have to be empirically adjusted in order to obtain acceptable results.

As previously stated, the neural network 300 of the preferred embodiment of the present invention 100 is adapted to receive human facial image data from two data sets—(1) an input human facial image data set 301 comprising the image captured by the camera 102 of the present invention 100 during a verification event, and (2) one of a plurality of human facial image data sets 323 comprising images previously captured and stored in the system's nonvolatile RAM 110 as enrolled, or authorized, users. Also according to the preferred embodiment of the present invention 100, the trained neural network 300 is further adapted to compare the input human facial image 301 with one or more of the enrolled human facial images 323 and thereafter generate an output indicative of recognition or non-recognition. In the preferred embodiment, the floating-point output of the trained neural network will tend toward one with increasing degrees of recognition. Conversely, the floating-point output will tend toward zero with decreasing degrees of recognition. A threshold may therefore be established whereby outputs greater than or equal to the threshold are deemed recognized outputs where after the appropriate responsive action of the system 100 will be to enable operation of the vehicle or unlocking of the vehicle's doors 130. Outputs less than the threshold may be deemed non-recognized outputs, where after the appropriate responsive action of the system 100 will be to disable operation of the vehicle or refusal to unlock the vehicle's doors 130. Those of ordinary skill in the art will recognize that the selected threshold may be a very important factor in preventing the unauthorized access to or use of the vehicle while minimizing the likelihood of excluding an authorized user 107. As a result, the threshold must be empirically selected, taking into careful consideration the desired overall system attributes.

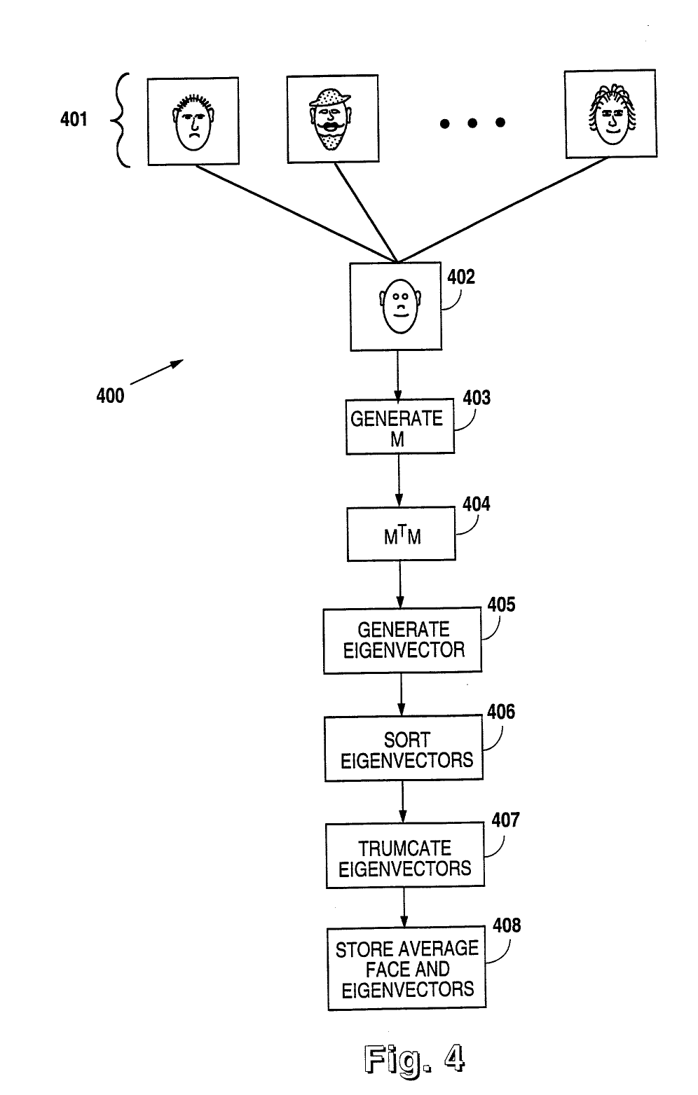

Referring now particularly to FIG. 4, and according to a second preferred embodiment of the present invention 100, a principal component analysis (PCA) 400 may be implemented as the system's face recognition engine 106. In a PCA embodiment 400, a set of training images 401, representative of a cross-section of the facial image characteristics of the general population, is transformed into an orthogonal set of basis vectors called eigenvectors. In the present invention 100, a subset of these eigenvectors, called eigenfaces, comprise an orthogonal coordinate system, detailed further herein, and referred to as face-space. In the preferred embodiment of the present invention 100, the face-space is generated according to the Karhunen-Loève Transform (KLT), readily known to those of ordinary skill in the art.

In implementing facial image recognition or verification with the KLT, an average facial image 402, comprising the average image of the set of training images 401, is first generated. Each of the training images 401 is then subtracted from the average facial image 402. The resulting difference images are thereafter arranged into a two-dimensional matrix M 403, wherein one dimension is representative of each training image 401 and the other dimension is representative of each pixel of each difference image. The transposition matrix MT of the two dimensional matrix M is then multiplied by the two-dimensional image M to arrive at a new matrix M^{T}M 404 from which eigenvalues and eigenvectors are generated 405. Those of ordinary skill in the art will have readily available myriad standard mathematical techniques for the generation of the necessary eigenvalues and eigenvectors; the particular implementation is therefore largely a matter of design choice. It is noted, however, that the matrices of the present invention may be very large, on the order of up to 16,000 by 16,000; therefore, the system implementation designer is cautioned that the selected mathematical technique must be able to efficiently handle large matrices. Applicant has found that one such method yielding acceptable performance is the Jacobi method for finding eigenvalues and eigenvectors, well known to those of ordinary skill in the art. In further implementation of the KLT, the generated eigenvectors are sorted from largest to smallest 406 where after the sorted set is truncated to retain only the first several eigenvectors 407. Applicant has found that only between about 5 and 20 eigenvectors need be retained for acceptable performance. Finally, the retained eigenvectors, also referred to as eigenfaces, as well as the average facial image, are stored 408 in the permanent, i.e. ROM, memory of the system's computer 102 for later use in recognizing or verifying input human facial images 301.

The retained eigenvectors, or eigenfaces, define an orthogonal coordinate system referred to as face-space. Any human facial image 301, 323 can be projected into this face-space where the location of the projected human facial image may be represented as a real-valued n×1 vector of coefficients, or coordinates, in the orthogonal system, where n is the number of retained eigenvectors, or eigenfaces. When two or more human facial images 301, 323 have been projected into the face-space, the Euclidean distance between the coordinates, or location, of each projected image 301, 323 represents the degree of similarity between the human facial images 301, 323. As known to those of ordinary skill in the art, the Euclidean distance is the distance between any two points in an n-dimensional coordinate system. The Euclidean distance is calculable according to the relationship

$$d ( x , y ) = \sqrt{{\sum }_{k = 1}^{n} {\vert y ( k ) - x ( k ) \vert}^{2}} ,$$

where d(x,y) is the Euclidean distance between the vectors x and y, y(k) is the k^{th} coordinate of vector y and x(k) is the k^{th} coordinate of vector x. A threshold value, similar to that employed in the neural network output channel 326 and subject to the same design considerations, can then be used to differentiate between recognition and non-recognition of input human facial images 301 as compared to a set of enrolled, or authorized, human facial images 323. If the projected input human facial image 301 resides at coordinates a Euclidean distance less than or equal to the threshold distance away from any one of the projected enrolled human facial images 323, the system 100 may deem the input human facial image 301 to be recognized and thereafter generate the appropriate response for a recognized, or authorized, user 107. Conversely, if the calculated Euclidean distances between the projected input human facial image 301 and each of the projected enrolled human facial images 323 are all greater than the threshold distance, the system 100 may deem the input human facial image 301 to be non-recognized and thereafter generate the appropriate response for a non-recognized, or unauthorized, user 107.

Human facial image data 301, 323 is projected into face-space by converting the human facial image 301, 323 into a small number of coefficients representative of the image's location, or coordinates, in the face-space as has been defined by the retained orthogonal eigenvectors or eigenfaces. These coefficients are generated by first subtracting 500 the previously generated average human facial image 402 from the human facial image 301, 323 to be projected into face-space, resulting in a difference image D_{P} 501. A dot product generator 502, well known to those of ordinary skill in the art, is then utilized to compute the dot products of the difference image D_{P} 501 with each previously generated eigenface 407. Each dot product results in a single numerical value 503 representative of one coordinate in face-space of the projected image 301, 323. All coordinates 503 taken together thus represent the projected human facial image's location 504 in face-space which may be stored 505 in the systems nonvolatile RAM 110, in the case of images 323 to be enrolled as authorized users 107, or RAM 109, in the case of input human facial images 301. As discussed herein above, these coordinates 504 may then be utilized by the system's computer 102 to generate 506 output signals indicative of recognition or non-recognition based upon the Euclidean distance there between.

As previously stated, a preprocessing function 112 must typically be implemented in order to achieve efficient and accurate processing by the chosen face recognition engine 106 of acquired human facial image data 301. Whether utilizing a neural network 300, PCA 400 or another equivalent face recognition engine, the preprocessing function 112 generally comprises elements adapted for (1) face finding 601, (2) feature identification 602, (3) determination of the existence within the acquired data of a human facial image 603, (4) scaling, rotation, translation and pre-masking of the captured human image data 604, and (5) contrast normalization and final masking 605. Although each of these preprocessing function elements 601, 602, 603, 604, 605 is described in detail further herein, those of ordinary skill in the art will recognize that some or all of these elements 601, 602, 603, 604, 605 may be dispensed with depending upon the complexity of the chosen implementation of the face recognition engine 106 and desired overall system attributes.

In the initial preprocessing step of face finding 601, objects exhibiting the general character of a human facial image are located within the acquired image data 600 where after the general location of any such existing object is tracked. Although those of ordinary skill in the art will recognize equivalent alternatives, three exemplary face finding techniques are (1) baseline subtraction and trajectory tracking, (2) facial template subtraction, or the lowest error method, and (3) facial template cross-correlation.

In baseline subtraction and trajectory tracking, a first, or baseline, acquired image is generally subtracted, pixel value-by-pixel value, from a second, later acquired image. As will be apparent to those of ordinary skill in the art, the resulting difference image will be a zero-value image if there exists no change in the second acquired image with respect to the first acquired image. However, if the second acquired image has changed with respect to the first acquired image, the resulting difference image will contain nonzero values for each pixel location in which change has occurred. Assuming that a human user 107 will generally be non-stationary with respect to the system's camera 103, and will generally exhibit greater movement than any background object, the baseline subtraction technique then tracks the trajectory of the location of a subset of the pixels of the acquired image representative of the greatest changes. During initial preprocessing 601, 602, this trajectory is deemed to be the location of a likely human facial image.

In facial template subtraction, or the lowest error method, a ubiquitous facial image, i.e. having only nondescript facial features, is used to locate a likely human facial image within the acquired image data. Although other techniques are available, such a ubiquitous facial image may be generated as a very average facial image by summing a large number of facial images. According to the preferred method, the ubiquitous image is subtracted from every predetermined region of the acquired image, generating a series of difference images. As will be apparent to those of ordinary skill in the art, the lowest error in difference will generally occur when the ubiquitous image is subtracted from a region of acquired image data containing a human facial image. The location of the region exhibiting the lowest error, deemed during initial preprocessing 601, 602 to be the location of a likely human facial image, may then be tracked.

In facial template cross-correlation, a ubiquitous image is cross-correlated with the acquired image to find the location of a likely human facial image in the acquired image. As is well known to those of ordinary skill in the art, the cross-correlation function is generally easier to conduct by transforming the images to the frequency domain, multiplying the transformed images, and then taking the inverse transform of the product. A two-dimensional Fast Fourier Transform (2D-FFT), implemented according to any of myriad well known digital signal processing techniques, is therefore utilized in the preferred embodiment to first transform both the ubiquitous image and acquired image to the frequency domain. The transformed images are then multiplied together. Finally, the resulting product image is transformed, with an inverse FFT, back to the time domain as the cross-correlation of the ubiquitous image and acquired image. As is known to those of ordinary skill in the art, an impulsive area, or spike, will appear in the cross-correlation in the area of greatest correspondence between the ubiquitous image and acquired image. This spike, deemed to be the location of a likely human facial image, is then tracked during initial preprocessing 601, 602.

Once the location of a likely human facial image is known, feature identification 602 is employed to determine the general characteristics of the thought-to-be human facial image for making a threshold verification that the acquired image data contains a human facial image and in preparation for image normalization. Feature identification preferably makes use of eigenfeatures, generated according to the same techniques previously detailed for generating eigenfaces, to locate and identify human facial features such as the eyes, nose and mouth. The relative locations of these features are then evaluated with respect to empirical knowledge of the human face, allowing determination of the general characteristics of the thought-to-be human facial image as will be understood further herein. As will be recognized by those of ordinary skill in the art, templates may also be utilized to locate and identify human facial features according to the time and frequency domain techniques described for face finding 601.

Once the initial preprocessing function elements 601, 602 have been accomplished, the system is then prepared to make an evaluation 603 as to whether there exists a facial image within the acquired data, i.e. whether a human user 107 is within the field of view 131 of the system's camera 103. According to the preferred method, the image data is either accepted or rejected based upon a comparison of the identified feature locations with empirical knowledge of the human face. For example, it is to be generally expected that two eyes will be found generally above a nose, which is generally above a mouth. It is also expected that the distance between the eyes should fall within some range of proportion to the distance between the nose and mouth or eyes and mouth or the like. Thresholds are established within which the location or proportion data must fall in order for the system to accept the acquired image data as containing a human facial image. If the location and proportion data falls within the thresholds, preprocessing continues. If, however, the data falls without the thresholds, the acquired image is discarded.

Threshold limits may also be established for the size and orientation of the acquired human facial image in order to discard those images likely to generate erroneous verification results due to poor presentation of the user 107 to the system's camera 103. Such errors are likely to occur due to excessive permutation, resulting in overall loss of identifying characteristics, of the acquired image in the morphological processing 604, 605 required to normalize the human facial image data, as detailed further herein. Applicant has found that it is simply better to discard borderline image data and acquire a new, better image. For example, the system 100 may determine that the image acquired from a user 107 looking only partially at the camera 103, with head sharply tilted and at a large distance from the camera 103, should be discarded in favor of attempting to acquire 600 a better image, i.e. one which will require less permutation 604, 605 to normalize. Those of ordinary skill in the art will recognize nearly unlimited possibility in establishing the required threshold values and their combination in the decision making process. The final implementation will be largely dependent upon empirical observations and overall system implementation.

Although the threshold determination element 603 is generally required for ensuring the acquisition of a valid human facial image prior to subsequent preprocessing 604, 605 and eventual attempts by the face recognition engine 106 to verify 606 the authorization status of a user 107, it is noted that the determinations made may also serve to indicate a triggering event condition. As previously stated, one of the possible triggering event conditions associated with the theft prevention apparatus is the movement of a user 107 from within to without the field of view 131 of the system's camera 103. Accordingly, much computational power may be conserved by determining the existence 603 of a human facial image as a preprocessing function—continuously conducted as a background process. Once verified as a human facial image, the location of the image within the field of view 131 of the camera 103 may then be relatively easily monitored by the tracking functions detailed for face finding 601. The system 100 may thus be greatly simplified by making the logical inference that an identified known user 107 who has not moved out of sight, but who has moved, is the same user 107.

After the system 100 determines the existence 603 of human facial image data, and upon triggering of a verification event, the human facial image data is scaled, rotated, translated and pre-masked 604, as necessary. Applicant has found that the various face recognition engines 106 perform with maximum efficiency and accuracy if presented with uniform data sets. Accordingly, the captured image is scaled to present to the face recognition engine 106 a human facial image of substantially uniform size, largely independent of the user's distance from the camera 103. The captured image is then rotated to present the image in a substantially uniform orientation, largely independent of the user's orientation with respect to the camera 103. Finally, the captured image is translated to position the image preferably into the center of the acquired data set in preparation for masking, as will be detailed further herein. Those of ordinary skill in the art will recognize that scaling, rotation and translation are very common and well-known morphological image processing functions that may be conducted by any number of well known methods. Once the captured image has been scaled, rotated and translated, as necessary, it will reside within a generally known subset of pixels of acquired image data. With this knowledge, the captured image is then readily pre-masked to eliminate the background viewed by the camera 103 in acquiring 600 the human facial image. With the background eliminated, and the human facial image normalized, much of the potential error can be eliminated in contrast normalization 605, detailed further herein, and eventual verification 606 by the face recognition engine 106.

Because it is to be expected that the present invention 100 will be placed into service in widely varying lighting environments, the preferred embodiment includes the provision of a contrast normalization 605 function for eliminating adverse consequences concomitant the expected variances in user illumination. Although those of ordinary skill in the art will recognize many alternatives, the preferred embodiment of the present invention 100 comprises a histogram specification function for contrast normalization. According to this method, a histogram of the intensity and/or color levels associated with each pixel of the image being processed is first generated. The histogram is then transformed, according to methods well known to those of ordinary skill in the art, to occupy a predetermined shape. Finally, the image being processed is recreated with the newly obtained intensity and/or color levels substituted pixel-by-pixel. As will be apparent to those of ordinary skill in the art, such contrast normalization 605 allows the use of a video camera 103 having very wide dynamic range in combination with a video digitizer 104 having very fine precision while arriving at an image to be verified 301 having only a manageable number of possible intensity and/or pixel values. Finally, because the contrast normalization 605 may reintroduce background to the image, it is preferred that a final masking 605 of the image be performed prior to facial image verification 606. After final masking, the image is ready for verification 606 as described herein above.

In implementing the present invention 100, desired aspects of either theft prevention 101, authorized access 201, or any combination thereof, are first installed in a host vehicle. Once the desired system 100 is installed, at least one authorized user 107 is enrolled. With at least one enrolled user, the system is ready for operation, as detailed further herein. Finally, additional authorized users may be added to the system's enrollment database, or deleted therefrom, at any time after initial system setup.

In operation of either the theft prevention or authorized access aspects 101, 201 of the present invention 100, at least one human user 107 is first enrolled in the system 100 through the provided enrollment interface 114. In the case of enrollment interfaces 114 integrated within the host vehicle, the user 107 desiring enrollment will typically place the enrollment lock 115 into its enrollment condition by actuating the enrollment key 116. The enrollment condition of the system is then communicated through the enrollment interface 114 to the theft prevention or authorized access apparatus' computer 102. The computer 102 then instructs the system's camera 103 and digitizer 104 to acquire images for the purpose of generating at least one human facial image data set representative of the user 107 to be enrolled. The acquired images are then preprocessed for selection of the best human facial image or images. This selection may ordinarily be made, based upon conformance to the threshold limits established for the size and orientation of the acquired human facial image, after preprocessing for face finding, feature identification and determination of a human facial image. If the system 100 determines the existence within the acquired images of an acceptable human facial image, the acceptable image is then further preprocessed for scaling, rotation, translation, pre-masking, contrast normalization and final masking. Finally, the resulting human facial image data set 323 is stored within the system's nonvolatile RAM 110 as an enrolled, or authorized, user 107 and the system 100 may indicate to the user 107 that the enrollment operation was successful 129. If the system 100 determines that no acceptable human facial image has been acquired, the system 100 may automatically attempt acquisition of more images or, in the alternative, may indicate to the user 107 that an enrollment operation failure has occurred 129, after which the user may manually reinitiate the enrollment process taking increased care to position for good camera presentation.

In the case of enrollment interfaces 114 comprising a stand-alone computer 125 under password or other enrollment key 116 control, the user 107 desiring enrollment will typically place the enrollment lock 115, embodied within the stand-alone computer 125, into its enrollment condition by entering an authorized password or actuating any other enrollment key 116 which may be associated with the stand-alone computer 125. Once the enrollment condition is communicated to the stand-alone computer 125, the stand-alone computer 125 instructs the camera 126 and digitizer 127 each associated therewith to acquire images for the purpose of generating at least one human facial image data set representative of the user 107 to be enrolled. The acquired images are then preprocessed for selection of the best human facial image or images. This selection may ordinarily be made, based upon conformance to the threshold limits established for size and orientation of the acquired human facial image, after preprocessing for face finding, feature identification and determination of a human facial image. If the stand-alone computer 125 determines the existence within the acquired images of an acceptable human facial image, the acceptable image is then further preprocessed for scaling, rotation, translation, pre-masking, contrast normalization and final masking. Finally, the resulting human facial image data set 323 is stored within the stand-alone computer's RAM or disk access storage for eventual electronic transfer to the nonvolatile RAM 110 of the theft prevention or authorized access apparatus' computer 102. The user 107 may then be informed of a successful enrollment operation 129. If the stand-alone computer 125 fails to determine that an acceptable human facial image has been acquired, the stand-alone computer 125 may automatically attempt acquisition of more images or, in the alternative, may indicate to the user 107 that an enrollment operation failure has occurred 129, after which the user 107 may manually reinitiate the enrollment process taking increased care to position for good camera presentation.

At any time after initial system setup, i.e. enrollment of at least one authorized user, additional users may be added to the system's enrollment database through either of the foregoing described methods, or any equivalent thereof, and/or previously enrolled authorized users may be deleted from the system's enrollment database. In the preferred embodiment of the present invention 100, previously enrolled authorized users are deleted from the system's enrollment database by first actuating the enrollment key 116 to place the enrollment lock 115 into the delete user condition and then identifying the user 107 to be deleted. In those embodiments comprising an enrollment interface 114 integrated into the host vehicle, the user 107 to be deleted may be identified by communicating 129 by any conventional method, including but not limited to keypad entry, voice recognition or other signaling, the user identification, as assigned during enrollment, to the system's computer 102. In those embodiments comprising a stand-alone computer interface 125, the user 107 to be deleted may be deleted according to the method described for embodiments comprising a host vehicle integrated enrollment interface 114 and/or the user 107 to be deleted may be identified by first viewing, on the stand-alone computer's monitor, stored images of enrolled users 323 and then selecting the user 107 to be deleted. Previously enrolled users may also be automatically deleted from the system's enrollment database after passage of a predetermined time period, e.g. thirty days, during which period the user 107 has not operated or accessed the host vehicle.

In operation of the theft prevention aspects 101 of the present invention 100, the triggering event condition will typically be either an attempt to start the vehicle or the opening of one or more of the vehicle's doors 130 while the vehicle is running such as, for example, would be the case in an attempted carjacking. When a user 107 attempts to start the vehicle, the user's actuation of the vehicle's ignition switch 120 is communicated through the triggering event interface 117 to the theft prevention aspects' computer 102. Likewise, when a door 130 of the vehicle is opened, the actuation of the door's door sensing switch 118, and the operational status of the vehicle's engine, is communicated through the triggering event interface 117 to the theft prevention aspects' computer 102. In the preferred embodiment of the present invention 100, a triggering event condition also takes place when a previously verified user 107 moves from within to without the field of view 131 of the theft prevention aspects' camera 103. This triggering event condition, determined by the computer 102 within the preprocessing function, is internally communicated. Once any of these triggering event conditions is communicated to the computer 102, the computer 102 instructs the system's camera 103 and digitizer 104 to acquire images for the purpose of generating at least one input human facial image data 301 set representative of the user 107 to be verified.

Following acquisition 600, the acquired images are preprocessed 601, 602, 603 for selection of the best human facial image or images. As in the enrollment operation, this selection may ordinarily be made, based upon conformance to the threshold limits established for the size and orientation of the acquired human facial image, after preprocessing for face finding 601, feature identification 602 and determination of a human facial image 603. If the system 100 determines the existence within the acquired images of an acceptable human facial image, the acceptable image is then further preprocessed for scaling, rotation, translation and pre-masking 604 and contrast normalization and final masking 605. Finally, the resulting human facial image data set is stored within the system's RAM 109 or nonvolatile RAM 110 as an input human facial image data set 301 to be subjected, as detailed further herein, to verification 606 by the implemented face recognition engine 106 where after an appropriate responsive action 607, 608 is generated.

If the system 100 determines that no acceptable human facial image has been acquired, the system 100 will preferably automatically attempt acquisition of more images 600 for a predetermined time period such as, for example, one minute. This predetermined time period serves to prevent an unnecessary or premature negative responsive action 608 in the case where the authorized user 107 has simply not yet fully entered the vehicle or has only temporarily moved from within the camera's field of view 131 such as may be the case when the user reaches to examine a map or turns to check the vehicle's blind spot. During the predetermined time period for further acquisition of images, the system 100 preferably indicates to the user 107 that a triggering event operation failure has occurred by, for example, sounding a buzzer 135 or other like device warning of the imminent actuation of a negative responsive action 608, such as the activation of the vehicle's alarm system 134 or disabling of the vehicle's engine. The user 107 may then take increased care to position for good camera presentation or, in the case of a surreptitious user, may take the opportunity to flee the vehicle, still intact, and avoid the long prison term concomitant arrest and conviction for grand theft auto.

Those of ordinary skill in the art will recognize that the time period set for acquisition of further images 107 should be carefully selected by balancing the interest of the authorized individual in avoiding the embarrassment of a false alarm with the shared interests of the state and general public in not giving a car thief too much of a head start. Applicant has found that a period within the range of from about ten seconds to about one minute serves justice. In any case, if the triggering event condition is not followed within the allotted time period by the acquisition of an acceptable human facial image, a negative responsive action 608 is generated, as detailed further herein, without further preprocessing 604, 605 or verification 606.

If the system has successfully acquired an acceptable human facial image, the generated input human facial image data set 301 must then be subjected to verification 606 by the implemented face recognition engine 106 in order to determine the appropriate responsive action 607, 608. Verification 606 by the face recognition engine 106, once implemented as detailed herein above, is relatively straightforward. Each enrolled human facial image data set 323 is in turn compared by the theft prevention aspects' computer 102 with the input human facial image data set 301 until either a recognition output is generated or every enrolled human facial image data set 323 has been compared with the input human facial image data set 301. If a recognition output is generated, an appropriate positive responsive action 607 is effected through the system's response interface 121. If, conversely, each comparison yields a non-recognition output, an appropriate negative responsive action 608 is effected through the system's response interface 121.

In the case of the theft prevention aspects 101 of the present invention 100 being triggered by an attempt to start the vehicle, the negative responsive action 608 is preferably disabling, or not enabling, the vehicle's motor or engine and activation of the vehicle's alarm system 134. Accordingly, the preferred positive responsive action 607 is enabling of the vehicle's motor or engine and deactivation, as necessary, of the vehicle's alarm system 134. In the case of the theft prevention aspects 101 of the present invention 100 being triggered by the opening of one or more of the vehicle's doors 130 while the motor or engine is running or by movement of a verified user 107 from within to without the field of view 131 of the theft prevention aspects' computer 102, the negative responsive action 608 is preferably, after a predetermined time period, disabling of the vehicle's motor or engine and activation of the vehicle's alarm system 134. This predetermined time period is set to allow the occupants of the vehicle sufficient opportunity to safely flee the vehicle and to even allow a carjacker temporary use of the vehicle in order that some distance may be placed between the vehicle and its assailant. The preferred positive responsive action 607 is the continued enabled status of the vehicle's motor or engine and continued deactivation of the vehicle's alarm system 134. Finally, the indication of an imminent negative responsive action 608 by, for example, sounding a buzzer 135 or other like device is also preferably effected through the response interface 121.

In operation of the authorized access aspects 201 of the present invention 100, the triggering event condition will typically be either an attempt to operate the vehicle's door handle or actuation of an independent switch 203 specifically adapted for signaling the user's desired access to the vehicle. When a user attempts to operate the door handle, actuation of the door handle sensing switch 202 is communicated through the triggering event interface 117 to the authorized access aspects' computer 102. Likewise, a user's actuation of a specifically adapted switch 203 is also communicated through the triggering event interface 117 to the authorized access aspects' computer 102. Once either of these triggering event conditions is communicated to the computer 102, the computer 102 instructs the system's camera 103 and digitizer 104 to acquire images for the purpose of generating at least one input human facial image data set 301 representative of the user 107 to be verified.

Following acquisition 600 the acquired images are preprocessed 601, 602, 603 for selection of the best human facial image or images. As in the enrollment operation and operation of the theft prevention aspects 101 of the present invention 100, this selection may ordinarily be made, based upon conformance to the threshold limits established for the size and orientation of the acquired human facial image, after preprocessing for face finding 601, feature identification 602 and determination of a human facial image 603. If the system 100 determines the existence within the acquired images of an acceptable human facial image, the acceptable image is then further preprocessed for scaling, rotation, translation and pre-masking 604 and contrast normalization and final masking 605. Finally, the resulting human facial image data set is stored within the system's RAM 109 or nonvolatile RAM 110 as an input human facial image data set 301 to be subjected, as detailed further herein, to verification 606 by the implemented face recognition engine 106 where after an appropriate responsive action 607, 608 is generated.

If the system 100 determines that no acceptable human facial image has been acquired, the system 100 will preferably automatically attempt acquisition of more images 600 for a predetermined time period such as, for example, one minute. Because the authorized user 107 will know that the failure of the vehicle's doors 130 to unlock is indicative of the acquisition of no acceptable image, it is not necessary to provide further indication. If the vehicle's doors 130 do not unlock within a short time period, the authorized user 107 will know to position for better camera presentation. If within the time period set for acquisition of more images no acceptable human facial image is acquired, a negative responsive action 608 is generated, as detailed further herein, without further preprocessing 604, 605 or verification 606.

If the system 100 has successfully acquired an acceptable human facial image, the generated input human facial image data set 301 must then be subjected to verification 606 by the implemented face recognition engine 106 in order to determine the appropriate responsive action 607, 608. Verification 606 by the face recognition engine 106, once implemented as detailed herein above, is relatively straight forward. Each enrolled human facial image data set 323 is in turn compared by the authorized access aspects' computer 102 with the input human facial image data set 301 until either a recognition output is generated or every enrolled human facial image data set 323 has been compared with the input human facial image data set 301. If a recognition output is generated, an appropriate positive responsive action 607 is effected through the system's response interface 121. If, conversely, each comparison yields a non-recognition output, an appropriate negative responsive action 608 is effected through the system's response interface 121.

The preferred negative responsive action 608 for the authorized access aspects 201 of the present invention 100 is the prevention of the unlocking of the vehicle's doors 130 and activation of the vehicle's alarm system 134. Accordingly, the preferred positive responsive action 607 is the unlocking of the vehicle's doors 130 and deactivation of the vehicle's alarm system 134.

While the foregoing description is exemplary of the preferred embodiments of the present invention 100, those of ordinary skill in the relevant arts will recognize the many variations, alterations, modifications, substitutions and the like as are readily possible, especially in light of this description, the accompanying drawings and claims drawn hereto. For example, the well known Cottrell auto-associator training technique may be used to adjust the weights of a neural network 300 to form a structure equivalent to that described for the PCA 400. According to the Cottrell auto-associator, the output layer 304, having the same number of neuron-like units 307 as found in the input layer 302, of a neural network 300 is trained to always produce an output identical to the neural network's input. The hidden layer 303 of the neural network 300 is designed to have substantially fewer neuron-like units 306 than has the input layer 302 and output layer 304. As will be better understood further herein, giving the hidden layer 303 between about 5 and 20 neuron-like units 306 will form an equivalent to the PCA 400 described herein above. After the neural network 300 is fully trained, the output layer 304 is discarded in favor of the hidden layer 303, which then becomes the neural network's output layer in implementation. As will be recognized by those of ordinary skill in the art, each of the small number of implemented output layer outputs yields one eigenface coefficient 503. These coefficients 503 may then be considered the coordinates of images 301, 323 projected into face-space and utilized to determine the Euclidean distances there between, as described herein above with respect to the PCA 400.

As yet another example, a vitality sensor may be added whereby the present invention 100 may base its verification 606 determination at least in part upon the status of the input human facial image 301 being taken directly from a living being. Such a vitality sensor may comprise a processor for observing movement of the user's eyes or other features with respect to the overall facial image or may comprise other well known sensors not based upon facial recognition. By incorporating a vitality sensor, any attempt to defeat the system 100 by using a photograph, or other likeness, of an authorized user 107 will be obviated. In any case, because the scope of the present invention 100 is much broader than any particular embodiment, the foregoing detailed description should not be construed as a limitation of the scope of the present invention 100, which is limited only by the claims appended hereto.

What is claimed is:

1. An integrated biometric vehicle security system, comprising:
an image acquisition device adapted to generate at least one signal relative to a human facial image;
a processor associated with said image acquisition device adapted to operatively receive signals generated by said image acquisition device, said processor being adapted to generate an output relative to recognition of at least one said signal generated relative to the human facial image; and
a response interface associated with said processor, said response interface being adapted to effect a vehicle security measure responsive to said output relative to recognition.

2. The integrated biometric vehicle security system as recited in claim 1, further comprising:
an enrollment interface associated with said processor, said enrollment interface being adapted for enrolling at least one authorized human user.

3. The integrated biometric vehicle security system as recited in claim 2, wherein said enrollment interface comprises an enrollment lock.

4. The integrated biometric vehicle security system as recited in claim 3, wherein said enrollment lock comprises a tumbler lock.

5. The integrated biometric vehicle security system as recited in claim 3, wherein said enrollment lock comprises a cipher lock.

6. The integrated biometric vehicle security system as recited in claim 3, wherein said enrollment lock comprises a stand-alone computer.

7. The integrated biometric vehicle security system as recited in claim 3, wherein said enrollment lock is adapted for enabling said processor to store said signal generated relative to the human facial image as an authorized user data set.

8. The integrated biometric vehicle security system as recited in claim 7, wherein said enrollment lock is adapted for enabling said processor to delete a previously enrolled authorized user data set.

9. The integrated biometric vehicle security system as recited in claim 8, further comprising an enrollment key, said enrollment key being adapted for operative association with said enrollment lock.

10. The integrated biometric vehicle security system as recited in claim 9, wherein said enrollment key is adapted for preventing said enrollment lock from enabling said processor to store said signal generated relative to the human facial image as an authorized user data set.

11. The integrated biometric vehicle security system as recited in claim 9, wherein said enrollment key is adapted for preventing said enrollment lock from enabling said processor to delete a previously enrolled authorized user data set.

12. The integrated biometric vehicle security system as recited in claim 7, wherein said processor is adapted to compare said signal gene rated relative to a human facial image with said stored authorized user data set.

13. The integrated biometric vehicle security system as recited in claim 12, wherein said processor further comprises a face recognition engine, said face recognition engine being adapted to generate an output relative to recognition of at least one said signal generated relative to the human facial image.

14. The integrated biometric vehicle security system as recited in claim 13, wherein said face recognition engine comprises a neural network.

15. The integrated biometric vehicle security system as recited in claim 13, wherein said face recognition engine comprises a principal component analysis.

16. The integrated biometric vehicle security system as recited in claim 13, wherein said processor further comprises a pre-processor, said pre-processor being adapted for preparing said signal generated relative to the human facial image for processing by said face recognition engine.

17. The integrated biometric vehicle security system as recited in claim 13, wherein said processor further comprises a pre-processor, said pre-processor being adapted for screening said signal generated relative to the human facial image prior to further processing by said processor.

18. The integrated biometric vehicle security system as recited in claim 16, wherein said pre-processor is adapted to perform morphological operations on said signal generated relative to the human facial image.

19. The integrated biometric vehicle security system as recited in claim 18, wherein said pre-processor is adapted for determining the existence of human facial image characteristics within said signal generated relative to a human facial image.

20. The integrated biometric vehicle security system as recited in claim 19, wherein said processor further comprises a postprocessor, said postprocessor being adapted to determine the vehicle security measure based upon a comparison of said output relative to recognition with a threshold value.

21. The integrated biometric vehicle security system as recited in claim 1, further comprising a triggering event interface, said triggering event interface being adapted for signaling said processor to generate an output relative to recognition of the signal generated by said image acquisition device relative to the human facial image.

22. The integrated biometric vehicle security system as recited in claim 21, wherein said processor is adapted to control said image acquisition device in response to a signal provided by said triggering event interface.

23. The integrated biometric vehicle security system as recited in claim 21, wherein said processor is adapted to generate an output indicative of non-recognition when the signal provided by said triggering event interface is not followed within a pre-determinable period of time with generation by said image acquisition device of a signal relative to a human facial image having human facial image characteristics.

24. The integrated biometric vehicle security system as recited in claim 21, wherein said triggering event interface is adapted to indicate a user's desired use of the vehicle by providing a signal to said processor.

25. The integrated biometric vehicle security system as recited in claim 22, wherein said triggering event interface is adapted to provide a signal to said processor containing information indicating the manner of the user's desired use.

26. The integrated biometric vehicle security system as recited in claim 25, wherein said triggering event interface is adapted to provide a signal to said processor indicating a user's desired access to the interior of the vehicle.

27. The integrated biometric vehicle security system as recited in claim 25, wherein said triggering event interface is adapted to provide a signal to said processor indicating a user's desire to operate the vehicle's engine.

28. The integrated biometric vehicle security system as recited in claim 21, wherein said triggering event interface comprises an interconnection to the vehicle's door, said triggering event interconnection being adapted to detect the opening of the door.

29. The integrated biometric vehicle security system as recited in claim 28, wherein said response interface is adapted to disable the vehicle's engine when said triggering event interface detects the opening of a vehicle door and said processor does not within a pre-determinable period of time generate an output relative to recognition indicative of an authorized user.

30. The integrated biometric vehicle security system as recited in claim 29, wherein said response interface comprises an interconnection to the vehicle's internal microprocessor.

31. The integrated biometric vehicle security system as recited in claim 21, wherein said triggering event interface comprises an interconnection to the vehicle's ignition switch, said triggering event interconnection being adapted to detect the actuation of the ignition switch.

32. The integrated biometric vehicle security system as recited in claim 31, wherein said response interface is adapted to disable the vehicle's engine when said triggering event interface detects the actuation of the vehicle's ignition switch and said processor does not within a pre-determinable period of time generate an output relative to recognition indicative of an authorized user.

33. The integrated biometric vehicle security system as recited in claim 32, wherein said response interface comprises an interconnection to the vehicle's internal microprocessor.

34. The integrated biometric vehicle security system as recited in claim 21, wherein said triggering event interface comprises an interconnection to the vehicle's door handle, said triggering event interconnection being adapted to detect the operation of the door handle.

35. The integrated biometric vehicle security system as recited in claim 34, wherein said response interface is adapted to unlock the vehicle's door when said triggering event interface detects the operation of the vehicle's door handle and said processor generates an output relative to recognition indicative of an authorized user.

36. The integrated biometric vehicle security system as recited in claim 35, wherein said response interface comprises an interconnection to the vehicle's internal microprocessor.

37. The integrated biometric vehicle security system as recited in claim 35, wherein said response interface comprises an interconnection to the vehicle's door lock relay.

38. The integrated biometric vehicle security system as recited in claim 21, wherein said triggering event interface comprises an interconnection to a switch provided in a location exterior to the vehicle, said triggering event interconnection being adapted to detect actuation of the switch.

39. The integrated biometric vehicle security system as recited in claim 38, wherein said response interface is adapted to unlock the vehicle's door when said triggering event interface detects the actuation of the exteriorly provided switch and said processor generates an output relative to recognition indicative of an authorized user.

40. The integrated biometric vehicle security system as recited in claim 39, wherein said response interface comprises an interconnection to the vehicle's internal microprocessor.

41. The integrated biometric vehicle security system as recited in claim 39, wherein said response interface comprises an interconnection to the vehicle's door lock relay.

42. The integrated biometric vehicle security system as recited in claim 21, wherein said response interface comprises an interconnection to a vehicle alarm system, said vehicle alarm system interconnection being adapted to actuate said vehicle alarm system.
